(19) United States
(12) Patent Application Publication
(10) Pub. No.: US 2013/0189989 A1
(43) Pub. Date: Jul. 25, 2013

(54) REDIRECTION METHOD AND APPARATUS FOR TERMINAL

(71) Applicant: HUAWEI TECHNOLOGIES CO., LTD., Shenzhen (CN)

(72) Inventor: Shuhui Hu, Shenzhen (CN)

(73) Assignee: HUAWEI TECHNOLOGIES CO., LTD., Shenzhen (CN)

(21) Appl. No.: 13/793,435

(22) Filed: Mar. 11, 2013

Related U.S. Application Data
(63) Continuation of application No. PCT/CN2011/084397, filed on Dec. 21, 2011.

(51) Int. Cl. H04W 36/14

(52) U.S. Cl. CPC H04W 36/14
USPC 455/436

(57) ABSTRACT

In a redirection method for a terminal according to the present invention, an LTE base station sends a redirection message to the dual-mode terminal, where the redirection message contains a redirection target carrier configured by the LTE base station; the dual-mode terminal performs session negotiation with a CDMA access network, and knows a camping carrier specified by the CDMA access network, where both the redirection target carrier and the camping carrier are the preset carrier on which the dual-mode terminal fixedly camps in the CDMA network; when the dual-mode terminal is redirected from an LTE network to the CDMA network, the dual-mode terminal initiates an access process on the redirection target carrier in the CDMA network. The technical solution provided by the present invention reduces service interruption time when the dual-mode terminal is redirected from the LTE network to the CDMA network, thereby improving user experience.

### CROSS-REFERENCE TO RELATED APPLICATIONS

This application is a continuation of International Application No. PCT/CN2011/084397, filed on Dec. 21, 2011, which is hereby incorporated by reference in its entirety.

### FIELD OF THE INVENTION

The present invention relates to the field of communication technologies, and in particular, to a redirection method and apparatus for a terminal

### BACKGROUND OF THE INVENTION

Currently, existing CDMA (Code Division Multiple Access) operators tend to select an LTE (Long Term Evolution) technology as a next generation network in the future, so as to satisfy increasing demands for wireless data services. Because deployment of the LTE cannot be completed all at once, the operator generally deploys the LTE in a hot spot area in an early phase, and then gradually extends a deployment range. Such deploying manner is shown in FIG. 1, and an existing CDMA EVDO (Code Division Multiple Access Evolution Data Only) network of the operator has a wide coverage range, and is of broad coverage. An LTE network deployed in a hot spot area is overlaid on the EVDO, so as to form an overlapping coverage area of the EVDO and the LTE. In this case, when a dual-mode terminal in this overlapping coverage area is not suitable for performing a data service in the LTE network because, for example, an LTE signal weakens or the LTE is overloaded, the dual-mode terminal needs to be redirected from the LTE network to the CDMA EVDO network. As shown in FIG. 2, networking where a dual-mode terminal moves from an LTE network to a CDMA EVDO network is as follows:

(1) EVDO Network Entities

eAN (evolved Access Network): providing an air interface radio access function of the EVDO for the terminal

(2) LTE Network Entities

eNB (evolved Node B): providing an air interface radio access function of the LTE for the terminal.

(3) Core Network Entities

HSGW (HRPD Serving Gateway): providing a function of gateway convergence of data on a service plane for a plurality of eANs, and providing a function of PPP dial-up connection for the terminal

S-GW (Serving Gateway): providing a function of gateway convergence of data on the service plane for a plurality of eNodeBs.

PGW (Packet Gateway): an IP packet gateway, supporting access of EVDO and LTE networks, responsible for allocating an IP address to the terminal, and responsible for connecting the terminal to an IP network so that the terminal performs a data service.

However, the redirection method in the prior art causes that during a redirection process of the dual-mode terminal, an upper layer data service of the terminal is interrupted for a period of time, leading to poor user experience.

### SUMMARY OF THE INVENTION

Embodiments of the present invention provide a redirection method for a terminal, so as to reduce service interruption time of a dual-mode terminal during a redirection process.

In order to achieve the foregoing objective, one aspect of the present invention provides a redirection method for a terminal, including:

receiving, by a dual-mode terminal, a redirection message sent by an LTE base station, where the redirection message contains a redirection target carrier which is configured for the dual-mode terminal by the LTE base station, and the redirection target carrier is a preset carrier on which the dual-mode terminal fixedly camps in a CDMA network;

performing, by the dual-mode terminal, session negotiation with a CDMA access network, and knowing a camping carrier which is specified for the dual-mode terminal by the CDMA access network, where the camping carrier is the preset carrier on which the dual-mode terminal fixedly camps in the CDMA network; and

searching, by the dual-mode terminal, for the redirection target carrier in the CDMA network, and initiating an access process on the redirection target carrier.

Another aspect of the present invention further provides a dual-mode terminal, including:

a receiving unit, configured to receive a redirection message sent by an LTE base station, where the redirection message contains a redirection target carrier which is configured for the dual-mode terminal by the LTE base station, and the redirection target carrier is a preset carrier on which the dual-mode terminal fixedly camps in a CDMA network;

a session negotiation unit, configured to perform session negotiation with a CDMA access network, and know a camping carrier which is specified for the dual-mode terminal by the CDMA access network, where the camping carrier is the preset carrier on which the dual-mode terminal fixedly camps in the CDMA network;

a searching unit, configured to search for the redirection target carrier in the CDMA network; and

an access unit, configured to initiate an access process on the redirection target carrier.

In the redirection method for a terminal provided by the present invention, firstly a carrier on which a dual-mode terminal fixedly camps in a CDMA network is preset, and then an LTE base station sends a redirection message to the dual-mode terminal, where the redirection message contains a redirection target carrier configured by the LTE base station; the dual-mode terminal performs session negotiation with a CDMA access network, and knows a camping carrier which is specified for the dual-mode terminal by the CDMA access network, where both the redirection target carrier and the camping carrier are the preset carrier on which the dual-mode terminal fixedly camps in the CDMA network; when the dual-mode terminal is redirected from an LTE network to the CDMA network, the dual-mode terminal searches for the redirection target carrier in the CDMA network, and initiates an access process on the redirection target carrier in the CDMA network. Compared with the prior art, the technical solution provided by the present invention reduces the service interruption time when the dual-mode terminal is redirected from the LTE network to the CDMA network, thereby improving user experience.

### BRIEF DESCRIPTION OF THE DRAWINGS

To illustrate the technical solutions in the embodiments of the present invention or in the prior art more clearly, the following briefly introduces accompanying drawings required for describing the embodiments or the prior art. Apparently, the accompanying drawings in the following descriptions show merely some of the embodiments of the present invention, and a person of ordinary skill in the art may still derive other drawings from the accompanying drawings without creative efforts.

FIG. 1 is an air interface networking diagram of a CDAM EVDO network and an LTE network in the background technology;

FIG. 2 is a networking diagram where a dual-mode terminal moves from an LTE network to a CDMA EVDO network in the background technology;

FIG. 3 is a flow chart of a redirection method for a terminal according to an embodiment of the present invention;

FIG. 4 is a flow chart of a redirection method for a terminal according to an embodiment of the present invention; and

FIG. 5 is a structural diagram of a dual-mode terminal according to an embodiment of the present invention.

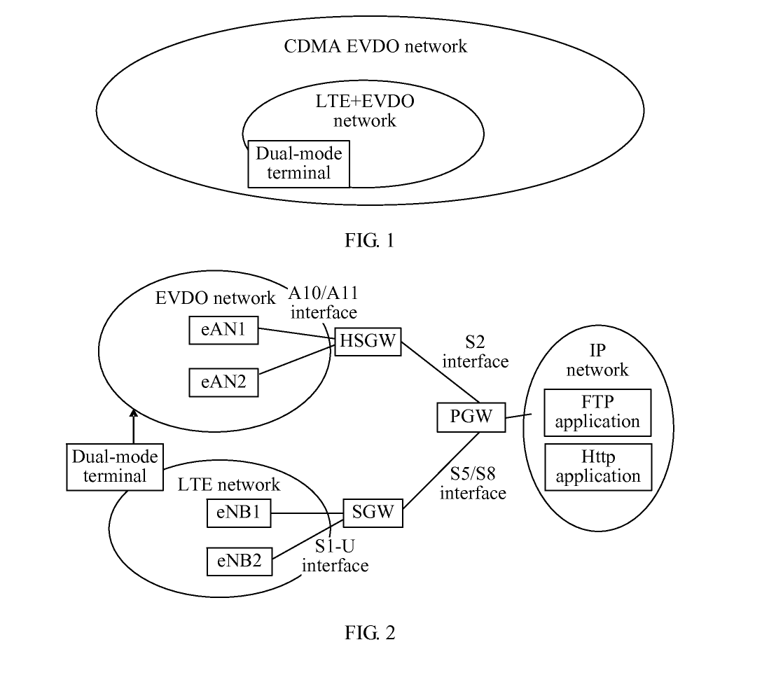

### DETAILED DESCRIPTION OF THE EMBODIMENTS

To make a person skilled in the art better understand the technical solutions of the present invention, the following clearly describes the technical solutions in the embodiments of the present invention with reference to the accompanying drawings in the embodiments of the present invention. Apparently, the described embodiments are merely part rather than all of the embodiments of the present invention. All other embodiments obtained by a person of ordinary skill in the art based on the embodiments of the present invention without creative efforts shall fall within the protection scope of the present invention.

The terms “system” and “network” in this document can always be exchanged for use in this document. The term “and/or” in this document shows only an association relationship for describing associated objects, and indicates that three relationships may exist, for example, A and/or B may indicate the following three cases: A exists separately, and both A and B exist, and B exists separately. In addition, the character “/” in this document usually indicates that the former and later associated objects are in an “or” relationship.

Currently, a method for redirecting a dual-mode terminal from an LTE network to a CDMA network is: When a dual-mode terminal needs to be redirected from an LTE network to a CDMA network, an LTE base station sends a redirection message to the dual-mode terminal, where the redirection message indicates that the dual-mode terminal is to be redirected to a certain carrier of the CDMA network, such as a carrier a1, the dual-mode terminal receives the redirection message, searches for the carrier al and receives a system message broadcast by the carrier a1, where the system message contains a list of carriers in the CDMA network. After receiving the list of carriers, the dual-mode terminal selects a camping carrier such as a carrier a2 according to a hash algorithm, and then receives a system message broadcast by the carrier a2, and initiates an access on the carrier a2, so as to complete a redirection process.

In the redirection method provided by the prior art, after receiving a system message broadcast by any carrier indicated by the LTE base station, the dual-mode terminal is required to select another camping carrier according to the hash algorithm, and receive a system message broadcast by the camping carrier again, and cannot initiate access before the system message is updated. The whole process contains updating the system message twice, which leads to that an upper layer data service of the dual-mode terminal needs to be interrupted for quite a long time.

In view of the foregoing defects, an embodiment of the present invention provides a redirection method for a terminal, where the method mainly includes:

receiving, by a dual-mode terminal, a redirection message sent by a long term evolution LTE base station, where the redirection message contains a redirection target carrier which is configured for the dual-mode terminal by the LTE base station, and the redirection target carrier is a preset carrier on which the dual-mode terminal fixedly camps in a CDMA network;

performing, by the dual-mode terminal, session negotiation with a CDMA access network, and knows a camping carrier which is specified for the dual-mode terminal by the CDMA access network, where the camping carrier is the preset carrier on which the dual-mode terminal fixedly camps in the CDMA network; and

searching, by the dual-mode terminal, for the redirection target carrier in the CDMA network, and initiating an access process on the redirection target carrier.

The present invention is described in further detail in the following with reference to accompanying drawings and specific embodiments:

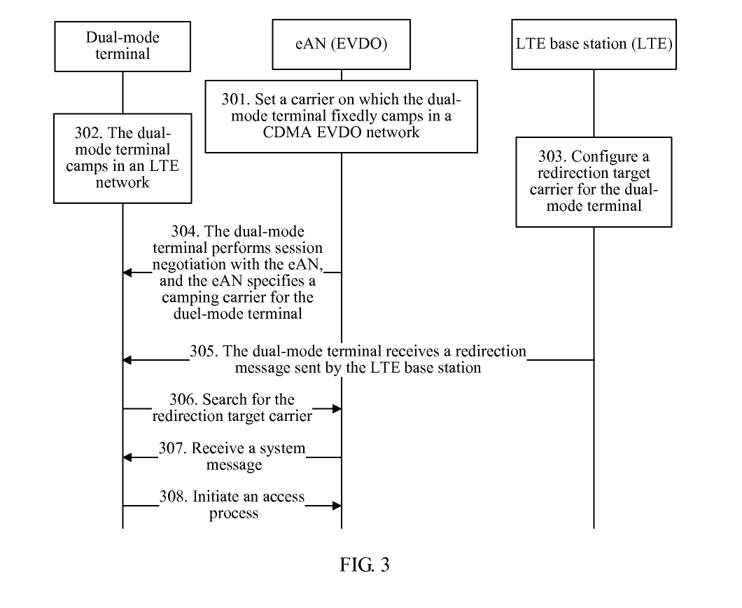

As shown in FIG. 3, a redirection method for a terminal provided by an embodiment of the present invention includes:

Step 301: Set a carrier on which the dual-mode terminal fixedly camps in a CDMA EVDO network.

In this step, the carrier on which the dual-mode terminal fixedly camps in the CDMA EVDO network may be preset by a telecommunication operator or a telecommunication equipment provider.

For example, if 3 carriers are deployed in the CDMA EVDO network, namely a carrier A1, a carrier a2 and a carrier a3, the carrier a2 may be set as the carrier on which the dual-mode terminal fixedly camps in the CDMA EVDO network.

Step 302: The dual-mode terminal camps in an LTE network, and is performing a data service.

The dual-mode terminal camps in the LTE network, establishes an air interface connection with an LTE base station, accesses an IP network, and performs the data service.

Step 303: The LTE base station configures, via a network management system, the carrier which is set in step 301 for fixed camping in the CDMA EVDO network, to a target carrier for redirection of the dual-mode terminal to the CDMA EVDO network.

For example, the LTE base station may configure the carrier a2 to the target carrier for the redirection of the dual-mode terminal to the CDMA EVDO network.

Step 304: The dual-mode terminal performs session negotiation with an eAN, and the eAN specifies, via the network management system, the carrier which is set in step 301 for fixed camping in the CDMA EVDO network, as a camping carrier for the redirection of the dual-mode terminal to the CDMA EVDO network.

The dual-mode terminal knows, during the session negotiation with the eAN, a camping carrier which is specified for the dual-mode terminal by the eAN. The dual-mode terminal may know the camping carrier in a plurality of manners, for example, the eAN may send a session negotiation message to the dual-mode terminal, where the session negotiation message contains a camping carrier which is specified for the dual-mode terminal by the eAN, and the dual-mode terminal knows the camping carrier immediately after receiving the session negotiation message.

In this embodiment, the eAN may specify the carrier a2 as the camping carrier for redirection of the dual-mode terminal from the LTE network to the CDMA EVDO network, and the session negotiation message sent by the eAN contains the camping carrier a2 specified for the dual-mode terminal by the eAN.

A condition for triggering the session negotiation performed by the dual-mode terminal with the eAN may be specified by the LTE base station, and the session negotiation may also be initiated when the dual-mode terminal is powered on; therefore, step 304 may occur before step 303, and may also occur after step 305.

Step 305: When having detected that the dual-mode terminal is not suitable for performing the data service in the LTE network, the LTE base station sends a redirection message to the dual-mode terminal, where the redirection message contains a redirection target carrier which is specified for the dual-mode terminal by the LTE base station;

That the dual-mode terminal is not suitable for performing the data service in the LTE network is a triggering reason why the dual-mode terminal is redirected from the LTE network to the CDMA EVDO network, and this triggering reason includes, but is not limited to that:

an LTE signal of the dual-mode terminal weakens or the LTE network is overloaded.

The redirection message sent by the LTE base station to the dual-mode terminal contains the redirection target carrier which is configured for the dual-mode terminal by the LTE base station, and the dual-mode terminal receives the redirection message.

In this embodiment, the LTE base station may send, to the dual-mode terminal, a redirection message containing the redirection target carrier a2 which is configured for the dual-mode terminal by the LTE base station in step 302.

Step 306: The dual-mode terminal searches for the redirection target carrier in the CDMA EVDO network.

After receiving the redirection message sent by the LTE base station and the session negotiation message sent by the eAN, the dual-mode terminal searches for the target carrier a2 which is for redirection to the CDMA EVDO network and is configured for the dual-mode terminal by the LTE base station.

Step 307: After finding the target carrier for redirection to the CDMA EVDO network, the dual-mode terminal starts receiving a system message.

The system message carries an access parameter of the eAN in the CDMA EVDO network, and the dual-mode terminal decides, according to the received parameter, whether to initiate an access, how much power is used to perform the access and at what time point the access is performed and so on.

In this embodiment, after finding the fixed camping carrier a2 in the CDMA EVDO network, the dual-mode terminal starts receiving a system message from the carrier a2.

Step 308: After receiving the system message completely, the dual-mode terminal initiates an access process on the redirection target carrier in the CDMA EVDO network.

In this embodiment, when initiating the access process on the redirection target carrier a2 in the CDMA EVDO network, the dual-mode terminal accesses an HRPD serving gateway HSGW/packet gateway PGW via the eAN, so as to complete the whole redirection process.

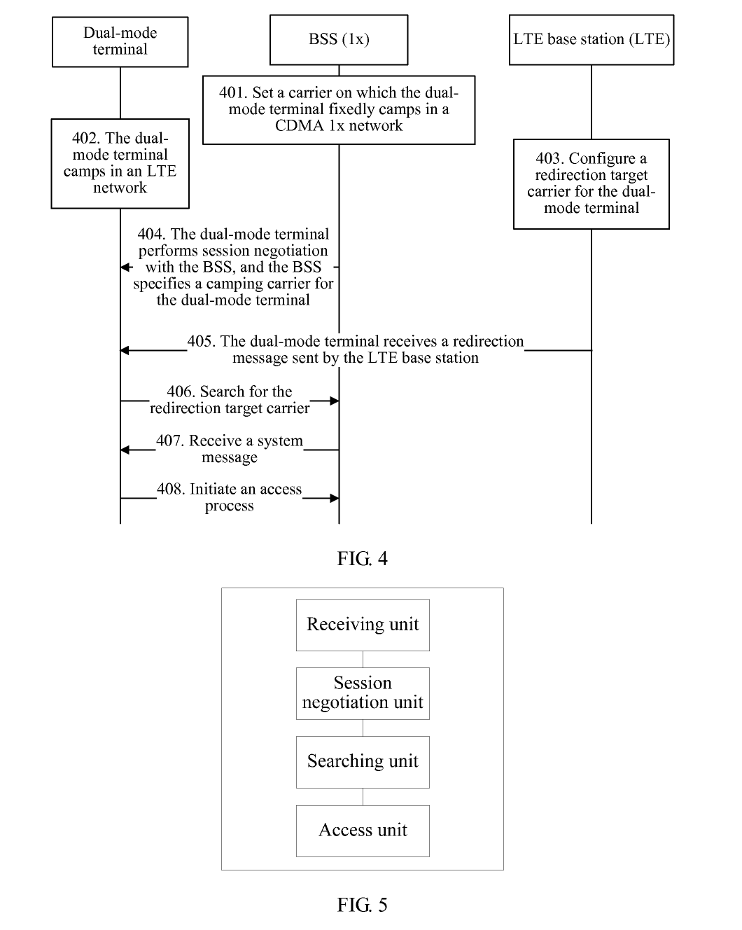

An embodiment of the present invention further provides a redirection method for a terminal, which, as shown in FIG. 4, is performed in approximately the same manner as the above embodiment, except that the CDMA EVDO network is replaced with a CDMA lx network, and correspondingly the evolved access network eAN is replaced with a base station subsystem BSS.

In the redirection method for a terminal provided by the embodiments of the present invention, the interruption time of the upper layer data service is reduced when the dual-mode terminal is redirected from the LTE network to the CDMA EVDO network or the CDMA lx network, thereby improving user experience.

Based on the foregoing method embodiments, an embodiment of the present invention further provides a dual-mode terminal. As shown in FIG. 5, the dual-mode terminal includes:

a receiving unit, configured to receive a redirection message sent by an LTE base station, where the redirection message contains a redirection target carrier which is configured for the dual-mode terminal by the LTE base station, and the redirection target carrier is a preset carrier on which the dual-mode terminal fixedly camps in a CDMA network;

a session negotiation unit, configured to perform session negotiation with a CDMA access network, and know a camping carrier which is specified for the dual-mode terminal by the CDMA access network, where the camping carrier is the preset carrier on which the dual-mode terminal fixedly camps in a CDMA network;

a searching unit, configured to search for the redirection target carrier in the CDMA network; and

an access unit, configured to initiate an access process on the redirection target carrier.

A person skilled in the art can clearly understand that, for the purpose of convenient and brief description, for a detailed working process of the foregoing system, apparatus and unit, reference may be made to the corresponding process in the foregoing method embodiments, and the details will not be described herein again.

In the several embodiments of the present invention, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on multiple network units. Part or all of the units may be selected according to the actual needs to achieve the objectives of the solutions of the embodiments.

In addition, functional units in the embodiments of the present invention may be integrated into one processing unit, or each of the units may exist alone physically, or two or more units are integrated into one unit. The integrated unit may be implemented in a form of hardware, or may be implemented in a form of a software functional unit.

When the integrated units are implemented in the form of a software functional unit and sold or used as an independent product, the integrated unit may be stored in a computer-readable storage medium. Based on such an understanding, the technical solutions of the present invention essentially, or the part contributing to the prior art, or all or a part of the technical solutions may be implemented in the form of a software product. The computer software product is stored in a storage medium and includes several instructions for instructing a computer device (which may be a personal computer, a server, or a network device) to perform all or a part of the methods described in the embodiments of the present invention. The storage medium includes: any medium that can store program codes, such as a USB flash disk, a removable hard disk, a read-only memory (ROM, Read-Only Memory), a random access memory (RAM, Random Access Memory), a magnetic disk, or an optical disk.

Only exemplary embodiments of the present invention are described above, which enable a person skilled in the art to understand or implement the present invention. Various modifications of the embodiments are apparent to a person of ordinary skill in the art, and general principles defined in the specification may be implemented in other embodiments without departing from the spirit or scope of the present invention. Therefore, the present invention will not be limited to the embodiments described in the document but extends to the widest scope that complies with the principle and novelty disclosed in the document.

What is claimed is:

1. A redirection method for a terminal, comprising:
receiving, by a dual-mode terminal, a redirection message sent by a long term evolution LTE base station, wherein the redirection message contains a redirection target carrier which is configured for the dual-mode terminal by the LTE base station, and the redirection target carrier is a preset carrier on which the dual-mode terminal fixedly camps in a CDMA network;
performing, by the dual-mode terminal, session negotiation with a code division multiple access CDMA access network, and knowing a camping carrier which is specified for the dual-mode terminal by the CDMA access network, wherein the camping carrier is the preset carrier on which the dual-mode terminal fixedly camps in the CDMA network; and
searching, by the dual-mode terminal, for the redirection target carrier in the CDMA network, and initiating an access process on the redirection target carrier.

2. The method according to claim 1, wherein the CDMA network is a CDMA EVDO network or a CDMA 1× network.

3. The method according to claim 1, before receiving, by a dual-mode terminal, a redirection message sent by an LTE base station, further comprising: configuring, by the LTE base station, the redirection target carrier for the dual-mode terminal via a network management system.

4. The method according to claim 1, before receiving, by a dual-mode terminal, a redirection message sent by an LTE base station, further comprising: specifying, by the CDMA access network, the camping carrier for the dual-mode terminal via a network management system.

5. The method according to claim 1, before receiving, by a dual-mode terminal, a redirection message sent by an LTE base station, further comprising:
Receiving, by the dual-mode terminal, the redirection message sent by the LTE base station after having detected that the dual-mode terminal is not suitable for performing a data service in an LTE network.

6. The method according to claim 5, wherein that the LTE base station has detected that the dual-mode terminal is not suitable for performing a data service in an LTE network is specifically that:
the LTE base station has detected that an LTE signal of the dual-mode terminal weakens or the LTE network is overloaded.

7. The method according to claim 1, after the dual-mode terminal finds the redirection target carrier in the CDMA network, further comprising:
receiving, by the dual-mode terminal, a system message, and initiating an access process on the redirection target carrier after receiving the system message.

8. A dual-mode terminal, comprising:
a receiving unit, configured to receive a redirection message sent by an LTE base station, wherein the redirection message contains a redirection target carrier which is configured for the dual-mode terminal by the LTE base station, and the redirection target carrier is a preset carrier on which the dual-mode terminal fixedly camps in a CDMA network;
a session negotiation unit, configured to perform session negotiation with a CDMA access network, and know a camping carrier which is specified for the dual-mode terminal by the CDMA access network, wherein the camping carrier is the preset carrier on which the dual-mode terminal fixedly camps in the CDMA network;
a searching unit, configured to search for the redirection target carrier in the CDMA network; and
an access unit, configured to initiate an access process on the redirection target carrier.

9. The dual-mode terminal according to claim 8, wherein the CDMA network is a CDMA EVDO network or a CDMA 1× network.

10. The dual-mode terminal according to claim 8, wherein the receiving unit further configured to receive the redirection message that is sent by the LTE base station after having detected that the dual-mode terminal is not suitable for performing a data service in an LTE network.
